(19) United States
(12) Patent Application Publication
(10) Pub. No.: US 2016/0007641 A1
(43) Pub. Date: Jan. 14, 2016

(54) Pigment Formulation

(71) Applicant: FMC Corporation, Philadelphia, PA (US)

(72) Inventors: Ana Catalina Ospina Posada, Santiago (CL); Luis Ricardo Morales, Santiago (CL); Maurice Gerard Lynch, Waterloo (BE); Javier Andres Lorca Levi, Talagante (CL)

(21) Appl. No.: 14/795,274

(22) Filed: Jul. 9, 2015

Related U.S. Application Data
(60) Provisional application No. 62/022,716, filed on Jul. 10, 2014.

(51) Int. Cl. A23L 1/275; A23L 2/58

(52) U.S. Cl. CPC A23L 1/2753; A23L 2/58; A23V 2002/00

(57) ABSTRACT

A stable aqueous suspension comprising a crystalline carotenoid; a stabilizer selected from the group consisting of propylene glycol alginate and gum acacia; a dispersant which comprises at least one sucrose ester of a fatty acid; and water. These suspensions exhibit desirable stability and are particularly useful for the production of red colors which are not animal sourced. In addition, consumable products comprising such suspension; and a solid composition formed by drying such suspension are disclosed.

### FIELD OF THE INVENTION

In one aspect, the present invention is directed to a stable aqueous suspension comprising a crystalline carotenoid; a stabilizer selected from the group consisting of propylene glycol alginate and gum acacia; a dispersant which comprises at least sucrose ester of a fatty acid; and water. These suspensions exhibit desirable stability and are particularly useful for the production of red colors which are not animal sourced. In other aspects, the present invention is directed to consumable products comprising such suspension; and to a solid composition formed by drying such suspension.

### BACKGROUND OF THE INVENTION

The appearance of many food, confectionery and pharmaceutical products is enhanced by the addition of color additives. Color additives are used in foods for many reasons including:

offsetting color loss due to exposure to light, air, temperature extremes, moisture and storage conditions; correcting natural variations in color; enhancing colors that occur naturally; providing color to colorless and “fun” foods; making food more attractive, appetizing and informative; and allowing consumers to identify products on sight, such as candy flavors or medicine dosages.

There are two aspects of stability that must be considered when evaluating the suitability of a color additive formulation: physical stability and color stability. With respect to physical stability, it is desirable that the color additive maintain its physical properties (such as particle size) over time under storage conditions so that it does not separate from the final product—for example, it is undesirable for dispersed crystals of a colorant to become too large such that they fall out of solution and settle to the bottom of a beverage, resulting in inconsistent coloration of such product. Color stability relates to the maintenance of a uniform color over time, such that the product does not change color upon storage. Color stability is typically measured in terms of DE 2000, a measurement established by the International Commission on Illumination (CIE) that measures perceptional uniformity based upon a corrected formula which takes into account differences in lightness, chroma and hue. In general, a DE 2000 of 5 or less indicates that an acceptable degree of color stability is present.

Due to consumer preferences, there is a need for food coloring additives which are not only effective, but which are derived from non-animal sources and are suitable for Kosher and/or Halal certifiable products. Unfortunately, it has been particularly difficult to find a red color additive which meets all of these demands. The most commonly used red pigment, carmine, is derived from insect sources and is thus not suitable for several uses. Anthocyanins and betanins are natural products useful for imparting red color in some formulations, but cannot be universally employed due to stability issues associated with pH (anthocyanin) and/or water contents and temperature (betanins).

Among the alternative sources which have been proposed for producing a red food coloring are carotenoids such as lycopene and beta-carotene which occur naturally in produce as well as in certain strains of fungi and algae. Carotenoids are generally insoluble in water and aqueous solutions, and thus must be formulated into an emulsion or suspension for many applications. Suspensions are generally preferred for red applications because, as is noted by Hartal et al (U.S. Pat. No. 5,965,183), crystalline lycopene has an intense red color, unlike dissolved or solubilized lycopene which has a yellow-orange color.

Unfortunately, merely dispersing crystalline carotenoid in an aqueous composition does not always result in the formation of a stable suspension. As is noted in Koguchi et al (U.S. Pat. No. 6,261,622) crystalline dispersions of carotenoids in general, and lycopene in particular, exhibit accelerated aggregation of the crystals when subjected to low temperatures of 10° C. or less, a property which makes such compositions unsuitable for many uses, particularly beverages.

Hartal et al proposes to overcome the difficulties of formulating a dispersion of lycopene crystals by suspending pulverized lycopene crystals in a water miscible or water soluble liquid, particularly glycerol, in order to inhibit the oxidation of such material. This publication discloses that in order to prevent agglomeration of the crystals, it is desirable to add a dispersant such as lecithin. However, as is evidenced in the Examples below, the addition of lecithin alone, or even the addition of lecithin in combination with glycerol will not always produce carotenoid suspensions exhibiting desirable stability.

Koguchi et al propose to overcome such difficulties by adding soybean extract fiber to pulverized crystals of lycopene. This publication discloses that, while such soybean extract fiber can optionally be employed in combination with “other known dispersion stabilizers” including macromolecular dispersion stabilizers (including gum arabic and propylene glycol alginate) the presence of such soybean extract fiber is essential to avoid crystal aggregation. Specifically, comparative formulations of crystalline carotenoids employing other listed macromolecular stabilizers (i.e., pectin and xanthan gum) without such fiber are shown to exhibit turbidity/crystal agglomeration when exposed to temperatures of 10° C. or less. The clear inference of this disclosure is that the other listed macromolecular dispersion stabilizers would be similarly ineffective. While soybean extract fiber itself is not a cause of concern, soy proteins are one of the most common food allergans (see Cordle, Soy Protein Allergy: Incidence and Relative Severity, J. Nutr. 134:1213-1219; 2004) and many manufacturers would prefer not to add an ingredient from soy to their products.

Isager et al (U.S. Pat. No. 6,190,686) discloses dispersions of natural hydrophobic pigments, including carotenoids, wherein such pigments are dispersed employing a hydrocolloid in the absence of a surface active substance. Nothing in such publication suggests that superior stability could be achieved by the addition of a dispersant which is a sucrose ester of a fatty acid.

Consequently, there is a need for a stabilized composition of crystalline carotenoids, particularly of red carotenoids such as lycopene or beta-carotene, which exhibits desirable stability, which does not contain animal sourced ingredients and which does not contain ingredients sourced from materials associated with food allergies.

### SUMMARY OF THE INVENTION

In one aspect, the present invention is directed to an aqueous suspension comprising: (a) a crystalline carotenoid; (b) a stabilizer selected from the group consisting of propylene glycol alginate and gum acacia; (c) a dispersant which comprises at least one sucrose ester of a fatty acid; and (d) water. Preferably, such suspension does not contain soybean extract fiber.

In another aspect, the present invention is directed to a consumable product, particularly a food, nutraceutical or pharmaceutical product, comprising such a suspension.

In yet another aspect, the present invention is directed to a solid composition formed by drying, particularly spray-drying, such a suspension.

### DETAILED DESCRIPTION OF THE INVENTION

In one aspect, the present invention is directed to an aqueous suspension comprising: (a) a crystalline carotenoid; (b) a stabilizer selected from the group consisting of propylene glycol alginate and gum acacia; (c) a dispersant which comprises at least one sucrose ester of a fatty acid; and (d) water. Preferably, such suspension does not contain soybean extract fiber.

The carotenoid pigment used in the suspensions of present invention may comprise any naturally-occurring or synthetic crystalline carotenoid compound. Specific examples thereof include β-carotene, lycopene, lutein, spheroidene, spirilloxanthin, bixin, violaxanthin, canthaxanthin, astaxanthin, cryptoxanthin, zeaxanthin, β-apo-8′-carotinal, and the like. Such compounds can be used alone or in combination of two or more thereof, depending upon the color desired. For creating a red color, lycopene and beta-carotene are preferred carotenoids.

The carotenoid is employed in crystalline in form, and should have an average particle size (d50) of less than 7 μm, preferably of less than 5 μm. Such particle size can be obtained by subjecting larger crystals to wet milling, employing means well known to one of skill in the art.

The stabilizer employed in the aqueous suspensions of this invention comprises at least one member of the group consisting of propylene glycol alginate and gum acacia.

According to the Food and Agricultural Organization of the United Nations, propylene glycol alginate (“PGA”) is an ester of alginic acid in which some of the carboxyl groups are esterified with propylene glycol, some neutralized with an appropriate alkali and some remain free. PGA typically has a molecular weight of between 10,000 and 600,000. PGA useful for the practice of this invention is commercially available, including PGA sold under the trademark PROTANAL® Ester by FMC Corporation.

Gum acacia, also known as gum arabic, is a mixture of polysaccharides and glycoproteins, and is a natural gum made of hardened sap taken from two species of the acacia tree; Senegalia (Acacia) senegal and Vachellia (Acacia) seyal. Gum acacia is commercially available from several sources.

Sucrose esters of fatty acids are well known to those of skill in the art, and are described in Addendum 5 of the Compendium of food additive specifications published by the Food and Agricultural Organization (FAO). This Compendium describes sucrose esters of fatty acids as being mono-, di- and tri-esters of sucrose with food fatty acids, prepared from sucrose and methyl and ethyl esters of food fatty acids of by extraction from sucroglycerides.

The suspensions of this invention typically comprise between 1 and 5 weight percent of crystalline carotenoid; between 1 and 30 weight percent of propylene glycol alginate and/or of gum acacia; between 0.5 and 5 weight percent of sucrose esters of fatty acids; and between 65 and 98 weight percent of water; based upon the total weight of the suspension. More typically, the crystalline carotenoid is present in an amount of between 1 and 3 weight percent; the propylene glycol alginate and/or of gum acacia is present in an amount of between 20 and 30 weight percent; and the sucrose ester of fatty acid in an amount between 1 and 3 weight percent; based upon the total weight of the suspension.

The suspensions may further comprise one or more additional food emulsifier. Such emulsifiers are well known to those of skill in the art and include polyglycerol fatty acid esters, such as Polyglycerol 10 Oleate HLB 14 (Polyaldo 10-1-0 from Lonza), lecithin, and ethoxylated sorbitan esters such as polyoxyethylene (20) sorbitan monooleate and polyoxyethylene (20) sorbitan monolaurate.

The suspensions may also further comprise an antioxidant. The anti-oxidant typically comprises between 0.05% and 2%; preferably of between 0.1% and 0.5%, based upon the weight weight of the suspension. Typically, the anti-oxidant is a tocopherol or other plant extract having anti-oxidant activity. Particularly preferred antioxidants include alpha tocopherol and ascorbyl palmitate.

The suspensions may further comprise a suitable food-compatible liquid such as glycerol, propylene glycol and/or ethanol. The addition of such liquids to the present composition may help to protect the suspension against oxidation and against microbial spoilage, as the food-compatible liquid can be chosen to have an activity against microorganisms, including antimicrobial activity as well as activity against yeast, fungi, etc., as for example glycerol, propylene glycol and ethanol.

Propylene glycol is the most preferred liquid as such material is GRAS (Generally Recognized as Safe), according to the US FDA; is an all-purpose food additive; and affords unexpectedly improved low temperature stability (see Example 5 below). Furthermore, propylene glycol is less viscous than other food compatible liquids (particularly glycerol), a property which aids in the milling process. A further substantial advantage of propylene glycol is that it is bacteriostatic, and therefore carotenoid compositions provided in a liquid which is essentially propylene glycol do not require the addition of preservatives. Another substantial advantage of propylene glycol is that it is water miscible and thus may allow a homogeneous distribution of the carotenoid in the food to which it is added.

The suspensions of this invention may be produced by adding carotenoid crystals to an aqueous medium comprising propylene glycol alginate and/or gum acacia as well as a sucrose acid of a fatty acid in water, and mixing under high shear conditions. Typically the mixture is milled, using a bead mill or similar device, until the crystals possess an average particle size of less than 7 microns.

The suspensions of this invention may be added to food, nutraceutical or pharmaceutical products by means well known to one of ordinary skill in the art. The amounts added to such products will depend upon the intensity of the final color desired.

In another aspect, the present invention is directed to a consumable product comprising a stable aqueous suspension comprising: (a) a crystalline carotenoid; (b) a stabilizer selected from the group consisting of propylene glycol alginate and gum acacia; (c) a dispersant which comprises at least one sucrose ester of a fatty acid; and (d) water. Preferably, such suspension does not contain soybean extract fiber.

Such consumable product may be a food, nutraceutical or pharmaceutical composition, and is typically in the form of a beverage. Due to the low temperature and low pH stability exhibited by the suspensions of this invention, the consumable product of this invention may be based upon a number of different carriers including soy milk and conventional dairy ingredients.

In yet another aspect, the present invention is directed to a solid composition formed by the steps of:

(I) preparing an aqueous suspension comprising: (a) a crystalline carotenoid; (b) a stabilizer selected from the group consisting of propylene glycol alginate and gum acacia; (c) a dispersant which comprises at least one sucrose ester of a fatty acid; and (d) water; and

(II) drying such aqueous suspension.

Preferably, the suspension prepared in step (I) does not contain soybean extract fiber.

While such drying may be accomplished by any means well known to one of skill in the art, preferably spray drying is employed.

The solid composition of this invention is preferably in powder form, such that it can be easily reconstituted into an aqueous suspension; or added in such form to a consumable product.

It is to be understood that each component, compound, substituent, or parameter disclosed herein is to be interpreted as being disclosed for use alone or in combination with one or more of each and every other component, compound, substituent, or parameter disclosed herein.

It is also to be understood that each amount/value or range of amounts/values for each component, compound, substituent, or parameter disclosed herein is to be interpreted as also being disclosed in combination with each amount/value or range of amounts/values disclosed for any other component(s), compounds(s), substituent(s), or parameter(s) disclosed herein and that any combination of amounts/values or ranges of amounts/values for two or more component(s), compounds(s), substituent(s), or parameters disclosed herein are thus also disclosed in combination with each other for the purposes of this description.

It is further understood that each lower limit of each range disclosed herein is to be interpreted as disclosed in combination with each upper limit of each range disclosed herein for the same component, compounds, substituent, or parameter. Thus, a disclosure of two ranges is to be interpreted as a disclosure of four ranges derived by combining each lower limit of each range with each upper limit of each range. A disclosure of three ranges is to be interpreted as a disclosure of nine ranges derived by combining each lower limit of each range with each upper limit of each range, etc. Furthermore, specific amounts/values of a component, compound, substituent, or parameter disclosed in the description or an example is to be interpreted as a disclosure of either a lower or an upper limit of a range and thus can be combined with any other lower or upper limit of a range or specific amount/value for the same component, compound, substituent, or parameter disclosed elsewhere in the application to form a range for that component, compound, substituent, or parameter.

### EXAMPLES

The following Examples are provided to illustrate the invention in accordance with the principles of this invention, but are not to be construed as limiting the invention in any way except as indicated in the appended claims.

### Examples 1 and 2 and Comparative Experiments A, B, C, D

Several aqueous suspensions of beta carotene in crystal form using gum acacia as a suspending agent were prepared with and without sucrose esters of fatty acids. The ingredients were blended together using a high shear stirrer and micronized in a bead mill from Netzsch. Grinding parameters are specified in Table 1. Formulations of the suspension are described in Table 2.

TABLE 1
Milling parameters

| Milling equipment | Netzsch LME-4 | |
|---|---|---|
| Beads size | 0.8-1.0 | mm |
| Max. Temperature | 45° | C. |
| Mill speed | 1800-2000 | rpm |
| Work pressure | 0.6 | bar |

| | |
|---|---|
| Filling volume | 80% |

TABLE 2
Suspensions of beta carotene

| | Example or Comparative Experiment | | | | | |
|---|---|---|---|---|---|---|
| | A | B | C | 1 | D | 2 |
| Beta carotene 96% | 0% | 0% | 0% | 0% | 3% | 3% |
| Beta carotene suspension in | 9% | 9% | 9% | 9% | 0% | 0% |
| Gum Acacia | 27% | 27% | 27% | 27% | 30% | 30% |
| Sunflower lecithin | 1.5% | 1.5% | 1.5% | 1.5% | 1.5% | 1.5% |
| DI water | 62.5% | 60.5% | 60.5% | 60.5% | 52.5% | 50.5% |
| Sucrose esters of fatty acids | 0% | 0% | 0% | 2% | 0% | 2% |
| Polyoxyethylene (20) sorbitan | 0% | 2% | 0% | 0% | 0% | 0% |
| monooleate | | | | | | |
| Polyoxyethylene (20) sorbitan | 0% | 0% | 2% | 0% | 0% | 0% |
| Glycerol | 0% | 0% | 0% | 0% | 13% | 13% |
| Total | 100 | 100 | 100 | 100 | 100 | 100 |

The suspensions were evaluated in their macroscopic aspect, one month after milling and also in its performance in skimmed milk (at room temperature at a dose of 0.0013% beta carotene).

The performance of the suspension as a coloring agent was rated in a semiquantitative scale from 0 to 5, for the following aspects: Color development, Hydrophilicity, Absence of visible particles. An hour later the applications were evaluated again to confirm if the suspension of the pigment was stable. Results are recorded in Table 3.

The applications were also characterized by colorimetry using a Hunter Lab colorflex EZ colorimeter. The ratio of coordinates a/b was calculated to describe the level of redness/yellowness. Results are presented in Table 4.

TABLE 3
Aspects of suspensions and performance

| | | | | Absence | |
|---|---|---|---|---|---|
| | Macroscopic | Color | | of | Stability |
| Sample | aspect of the | devel- | Hydro- | visible | after |
| ID | suspension | opment | philicity | particles | 1 hour |
| A | Very uneven | 0 | 0 | 0 | Color |
| | aspect. | | | | smeared at |
| | Multicolored | | | | the surface |
| | | | | | of |
| B | Two distinct | 1 | 3 | 4 | Some |
| | phases, with the | | | | pigment |
| C | Two distinct | 0 | 1 | 0 | Pigment |
| | phases, with the | | | | floating |
| 1 | Two distinct | 2 | 4 | 4 | No pigment |
| | phases, with the | | | | floating or |
| D | Uneven aspect. | 0 | 0 | 0 | Precipitated |
| | Some striations | | | | pigment |
| | of a brighter | | | | |
| 2 | Very even | 3 | 5 | 5 | No pigment |
| | aspect: one | | | | floating or |
| | phase, no | | | | precipitated |

TABLE 4
Colorimetric results in application

| Sample | | | | | |
|---|---|---|---|---|---|
| ID | L | a | b | a/b | Descriptor |
| A | 79.11 | −2.52 | 3.06 | −0.58 | No color development at all |
| B | 79.03 | 6.60 | 7.47 | 0.88 | Too orangey and poorly colored |
| C | 81.45 | −3.09 | 4.83 | −0.243 | No color development at all |
| 1 | 80.03 | 4.34 | 7.07 | 0.61 | No color development at all |
| D | 80.13 | 2.98 | 7.30 | 0.40 | No color development at all |
| 2 | 76.7 | 11.69 | 8.66 | 1.35 | Slightly redder than yellow. |

The above results show that the compositions of this invention which comprise gum acacia as well as sucrose esters of fatty acids exhibit unexpectedly desirable physical stability.

### Examples 3 and 4 and Comparative Experiment E

Suspension having the compositions set forth in Table 5 were prepared employing the process described above except the maximum milling temperature in Example 3 was 75° C.

TABLE 5

Example or
Comparative
Experiment

| | E | 3 |
|---|---|---|
| Beta carotene 96% | 3% | 3% |
| Gum Acacia | 14% | 14% |
| Sunflower lecithin | 1.2% | 1.2% |
| DI water | 33.8% | 31.8% |
| Sucrose esters of fatty acids | 0% | 2% |
| Polyoxyethylene (20) sorbitan monooleate | 28% | 28% |
| Propyleneglycol | 20% | 20% |
| Total | 100 | 100 |

As with the previous set of experiments, the suspensions were evaluated in their macroscopic aspect 1 month after milling and also in their performance in skimmed milk (at room temperature at a dose of 0.0013% beta carotene).

The performance of the suspension as a coloring agent was rated in a semiquantitative scale from 0 to 5, for the following aspects: Color development, Hydrophilicity, Absence of visible particles. One day later the applications were evaluated again to confirm if the suspension of the pigment was stable. Results are recorded in Table 6.

TABLE 6
Aspects of suspensions and performance

| | | | | Absence | |
|---|---|---|---|---|---|
| | Macroscopic | Color | | of | Stability |
| Sample | aspect of the | devel- | Hydro- | visible | after |
| ID | suspension | opment | philicity | particles | 1 day |
| E | Very uniform | 4 | 5 | 5 | A few visible |
| | aspect, one | | | | particles float |
| | phase, no | | | | at the surface |
| 3 | Very uniform | 4 | 5 | 5 | Uniform |
| | aspect, one | | | | suspension |
| | phase, no | | | | |

The applications were also characterized by colorimetry using a Hunter Lab colorflex EZ colorimeter. The ratio of coordinates a/b was calculated to describe the level of redness/yellowness. Results are presented in Table 7.

TABLE 7
Colorimetric results in application

| Sample ID | L | a | b | a/b | Descriptor |
|---|---|---|---|---|---|
| E | 68.96 | 24.88 | 12.73 | 1.95 | Pink color, good color |
| | | | | | development |
| 3 | 68.02 | 26.39 | 12.49 | 2.11 | Pink color, good color |
| | | | | | development |

The above results demonstrate the unexpectedly desirable stability provided by the compositions of this invention. Further, the higher a/b ratio observed indicates enhanced color properties.

### Example 5

Skim milk was colored with suspensions described in the previous experiments, at doses of 0.0013% beta carotene. The suspensions were chemically preserved with sodium benzoate (to avoid spoilage during the experiment) and stored in chilled conditions (4-5° C.) for 3 months. The stability of the applications was rated in a semiquantitative scale from 0 to 5, for presence of signs of pigment aggregation, precipitation, oil ringing, and evident discoloration. Observations were taken on a monthly basis, and results are presented in Table 8.

TABLE 8

| Example or | Stability rate | | | |
|---|---|---|---|---|
| Comparative | One | Two | Three | |
| Experiment | month | months | months | Type of defect detected |
| 2 | 2 | 2 | 2 | Pigment precipitate and |
| | | | | discoloration (bleaching) |
| E | 5 | 4 | 3 | Oil ringing |
| 3 | 5 | 5 | 4 | A few crystals floating |

The above results demonstrate that the compositions of the present invention which further comprise propylene glycol exhibit unexpectedly superior cold temperature stability.

### Example 6

### PGA-Lycopene Suspension Color Stability in Yogurt

In order to evaluate the color stability of a lycopene—PGA suspension in yogurt the following blend was prepared:

| Component | Percent by Weight |
|---|---|
| Lycopene Crystals 96% | 2.1 |
| DL alpha tocopherol | 0.3 |
| Ascorbyl palmitate | 0.2 |
| Manucol Ester M | 3.0 |
| Sucrose esters | 2.0 |
| Polyglycerol esters | 2.0 |
| Glycerin | 10.0 |
| Di-water | 80.4 |
| Total | 100.0 |

The mixture above was added at a concentration of 0.2% by weight to a commercial natural yogurt (Yogurt Soprole) containing 3.7% protein, 4.9% total fat and 7.5% carbohydrate and having a pH of 4.0 in Thermomix mixer and mixed until uniform. The resultant blend was placed into several containers and stored in a refrigerator at 5° C. Samples were periodically evaluated for their color stability employing a Colorflex EZ colorimeter. The results of such testing are presented in Table 9 below:

TABLE 9

| Day 1 | | | Week 1 | | | Week 2 | | | Week 3 | | | DE* |
|---|---|---|---|---|---|---|---|---|---|---|---|---|
| L | a | b | L | a | b | L | a | b | L | a | b | 2000 |
| 78.34 | 3.84 | 6.18 | 77.23 | 3.8 | 6.19 | 77.93 | 3.56 | 6.45 | 76.45 | 3.4 | 6.83 | 2.04 |

The above results indicate that the sample provided desirable color stability as indicated by the DE 2000 calculation.

What is claimed is:

1. An aqueous suspension comprising:
(a) a crystalline carotenoid;
(b) a stabilizer selected from the group consisting of propylene glycol alginate and gum acacia;
(c) a dispersant which comprises at least one sucrose ester of a fatty acid; and
(d) water.

2. The suspension of claim 1 wherein such composition comprises between 1 and 5 weight percent of crystalline carotenoid; between 1 and 30 weight percent of propylene glycol alginate and/or of gum acacia; between 0.5 and 5 percent by weight of sucrose esters of fatty acids; and between 65 and 98 weight percent of water; based upon the total weight of the suspension.

3. The suspension of claim 2 wherein such composition comprises between 1 and 3 weight percent of crystalline carotenoid; between 20 and 30 weight percent of propylene glycol alginate and/or of gum acacia; and between 1 and 3 weight percent of sucrose ester of fatty acid; based upon the total weight of the suspension.

4. The suspension of claim 1 wherein the carotenoid is selected from at least one member of the group consisting of β-carotene, lycopene, lutein, spheroidene, spirilloxanthin, bixin, violaxanthin, canthaxanthin, astaxanthin, cryptoxanthin, zeaxanthin, and β-apo-8′-carotinal.

5. The suspension of claim 4 wherein the carotenoid comprises at least one member of the group consisting of lycopene and beta-carotene.

6. The suspension of claim 1 wherein the stabilizer is propylene glycol alginate.

7. The suspension of claim 1 wherein the stabilizer is gum acacia.

8. The suspension of claim 1 wherein said composition further comprises one or more additional food emulsifier.

9. The suspension of claim 8 wherein said additional food emulsifier is selected from at least one member of the group consisting of polyglycerol fatty acid esters, lecithin, and ethoxylated sorbitan esters.

10. The suspension of claim 9 wherein said additional food emulsifier is selected from at least one member of the group consisting of polyoxyethylene sorbitan monooleate and polyoxyethylene sorbitan monolaurate.

11. The suspension of claim 1 wherein said suspension further comprises a food compatible liquid.

12. The suspension of claim 11 wherein said food compatible liquid is at least one member selected from the group consisting of glycerol, propylene glycol and ethanol.

13. The suspension of claim 12 wherein said food compatible liquid is propylene glycol.

14. The suspension of claim 1 wherein the carotenoid has a particle size d50 of less than 7 μm.

15. The suspension of claim 14 wherein the carotenoid has a particle size d50 of less than 5 μm.

16. The suspension of claim 1 wherein said suspension further comprises an antioxidant.

17. The suspension of claim 16 wherein said antioxidant is at least one member selected from the group consisting of alpha tocopherol and ascorbyl palmitate.

18. The suspension of claim 1 wherein said suspension does not contain soybean extract fiber.

19. A consumable product comprising the suspension of claim 1.

20. The consumable product of claim 19 wherein said food product is a beverage.

21. A solid composition produced by drying the suspension of claim 1.

22. The solid composition of claim 21 wherein said drying is accomplished by spray drying the suspension.
